(19) United States
(12) Patent Application Publication
(10) Pub. No.: US 2016/0062386 A1
(43) Pub. Date: Mar. 3, 2016

(54) Stationary Induction Electric Apparatus

(71) Applicant: Hitachi, Ltd., Tokyo (JP)

(72) Inventors: Satoshi ICHIMURA, Tokyo (JP); Naoyuki KURITA, Tokyo (JP); Naoya MIYAMOTO, Tokyo (JP); Takahide MATSUO, Tokyo (JP)

(21) Appl. No.: 14/819,773

(22) Filed: Aug. 6, 2015

(30) Foreign Application Priority Data
Aug. 28, 2014 (JP) 2014-173426

(51) Int. Cl. G05F 7/00

(52) U.S. Cl. CPC G05F 7/00

(57) ABSTRACT

A polyphase stationary induction electric apparatus includes an N-phase N-leg main magnetic path (where N is 3 or more); a main winding wound around each main leg; and a control magnetic flux generating unit that generates a control magnetic flux having a magnitude variable in a direction substantially orthogonal to any one of N-phase main magnetic fluxes at an intersection part of N main legs; the control magnetic flux generating unit controlling the magnitude of the control magnetic flux to make N-phase reactance variable.

### CROSS-REFERENCE TO RELATED APPLICATION

This application is based upon and claims the benefit of priority to the Japanese Patent Application No. 2014-173426, filed on Aug. 28, 2014, the entire contents of which are incorporated herein by reference.

### BACKGROUND OF THE INVENTION

1. Field of the Invention

The present invention relates to a polyphase stationary induction electric apparatus in which reactance is variable, and particularly to simplification of the structure of a polyphase stationary induction electric apparatus in which reactance is variable.

2. Description of the Related Art

Examples of the background art of the present invention include Japanese Patent Application Publication No. 2002-50524 (Patent Document 1). This publication discloses a three-phase reactor in which a pair of three-phase closed magnetic paths intersecting each other is formed such that central portions of corresponding legs of a pair of three-phase three-leg magnetic cores intersect each other, a pair of main windings for each phase is wound around each leg of one three-leg magnetic core, a pair of control windings is wound around each leg of the other three-leg magnetic core, the main windings are connected in series with each other such that magnetic fluxes of the pair of main windings of each leg face an intersection of the magnetic paths intersecting each other, the control windings are connected in series with each other such that induced voltages generated in the pair of control windings wound around each leg are canceled each other out by the magnetic fluxes produced by the main windings, a control circuit is connected to the open terminal side of the control windings to supply a DC control current, and the reactance of the main windings is continuously varied by controlling the magnetic reluctance of the magnetic paths common to the magnetic fluxes produced by the main windings and the magnetic fluxes produced by the control windings.

The conventional technology described in Patent Document 1 needs a total of six main windings, a total of two E-shaped control magnetic paths, and a total of six control windings to vary the reactance of the three-phase reactor. Thus, the constitution of the apparatus has been complicated to require a significant increase in cost.

### SUMMARY OF THE INVENTION

It is accordingly an object of the present invention to provide a polyphase stationary induction electric apparatus such as a three-phase reactor or the like in which reactance is made variable by the addition of a relatively simple device.

In order to solve the above problem, according to the present invention, there is provided a polyphase stationary induction electric apparatus including: an N-phase N-leg main magnetic path (where N is 3 or more); a main winding wound around each main leg; and a generating unit that generates a control magnetic flux having a magnitude variable in a direction substantially orthogonal to any one of N-phase main magnetic fluxes at an intersection part of the main magnetic path; the generating unit controlling the magnitude of the control magnetic flux to make N-phase reactance variable.

According to the present invention, it is possible to realize a polyphase stationary induction electric apparatus in which reactance is made variable by the addition of a relatively simple device.

### BRIEF DESCRIPTION OF THE DRAWINGS

Other objects and advantages of the invention will become apparent from the following description of embodiments with reference to the accompanying drawings in which:

FIG. 1 is a front view showing a constitution according to a first embodiment of the present invention;

FIG. 2 is a side view showing the constitution according to the first embodiment of the present invention;

FIG. 3 is a front view showing a constitution according to a second embodiment of the present invention;

FIG. 4 is a side view showing the constitution according to the second embodiment of the present invention;

FIG. 5 is a diagram showing the relationship between main magnetic fluxes in the second embodiment of the present invention;

FIG. 6 is a diagram showing the relationship between magnetic flux densities at an intersection part in the second embodiment of the present invention;

FIG. 7 is a side view showing a constitution according to a third embodiment of the present invention;

FIG. 8 is a front view showing a constitution according to a fourth embodiment of the present invention;

FIG. 9 is a side view showing the constitution according to the fourth embodiment of the present invention;

FIG. 10 is a front view showing a constitution according to a fifth embodiment of the present invention; and

FIG. 11 is a side view showing the constitution according to the fifth embodiment of the present invention.

### DESCRIPTION OF THE PREFERRED EMBODIMENTS

Embodiments will hereinafter be described with reference to the drawings.

### First Embodiment

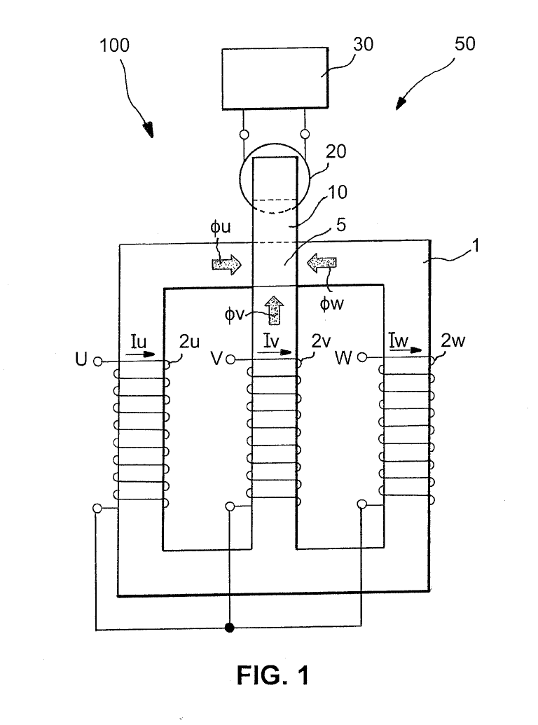

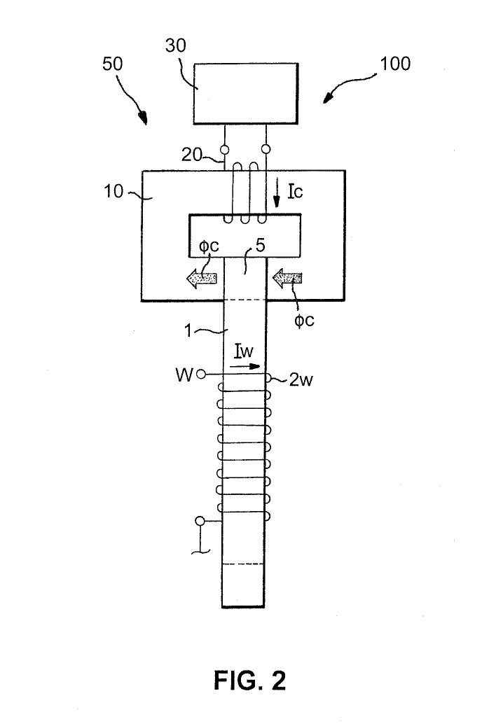

A first embodiment will be described with reference to FIG. 1 and FIG. 2. FIG. 1 and FIG. 2 are a front view and a side view, respectively, showing a constitution of a three-phase variable reactor according to the present embodiment.

The constitution of the three-phase variable reactor 100 according to the present embodiment will be described below. Main legs of a three-phase three-leg main magnetic path 1 are wound with main windings 2u, 2v, and 2w, respectively, one ends of the respective main windings are connected to each other at a neutral point, and other ends of the respective main windings are connected to respective phases of a three-phase alternating-current power source not shown in the figures, thereby constituting a Y-connection. A C-shaped control magnetic path 10 is attached to an intersection part 5 of the main magnetic path 1 to hold the intersection part 5 from left and right sides in FIG. 2. A control winding 20 is wound around the control magnetic path 10. Two terminals of the control winding 20 are connected to a control power supply 30. The control magnetic path 10, the control winding 20, and the control power supply 30 integrally constitute a control magnetic flux generating unit 50. Note that the control magnetic path 10 is formed in a bilateral symmetric shape with respect to the intersection part 5 in FIG. 2.

The operation of the three-phase variable reactor according to the present embodiment will next be described. When the three-phase alternating-current power source not shown in the figures applies sinusoidal voltages shifted in phase from each other by 2π/3 to the respective main windings 2u, 2v, and 2w, main magnetic fluxes Φu, Φv, and Φw that temporally change in a sinusoidal manner are generated in the respective main legs according to the magnitudes and phases of the applied voltages. Supposing that the directions of arrows shown in FIG. 1 are each positive, and that the magnetic fluxes Φv and Φw are delayed in phase with respect to the magnetic flux Φu by 2π/3 and 4π/3, respectively, the magnitudes of the respective main magnetic fluxes at a given time t are expressed by the following equations, respectively.

Φu=Φ0·sin(2πf·t) (1)

Φv=Φ0·sin(2πf·t−2π/3) (2)

Φw=Φ0·sin(2πf·t−4π/3) (3)

where f denotes an AC frequency, and Φ0 denotes a maximum magnetic flux.

Moreover, the following relational expression holds between the main magnetic fluxes irrespective of time.

Φu+Φv+Φw=0 (4)

The above relational expression means that main magnetic fluxes flowing into the three-leg intersection part 5 of the main magnetic path 1 are equal to main magnetic fluxes flowing out of the three-leg intersection part 5, and that no main magnetic flux passes through the control magnetic path 10. In actuality, leakage components of the main magnetic fluxes pass in the vicinity of connections to the intersection part 5. However, a sum of components in the direction of a control magnetic flux Φc indicated by an arrow in FIG. 2, the components being included in the leakage components of the main magnetic fluxes, is zero. Note that exciting currents Iu, Iv, and Iw necessary to generate the respective main magnetic fluxes according to the magnetic reluctance of the main magnetic path 1 flow through the respective windings. Ratios between the magnitudes of the respective main magnetic fluxes and the magnitudes of the exciting currents correspond to reactance. There is a relation such that the higher the magnetic reluctance of the main magnetic path 1, the lower the reactance.

When the control power supply 30 is operated to pass a DC control current Ic through the control winding 20 and thereby generate a control magnetic flux Φc shown in FIG. 2 in the control magnetic path 10, the control magnetic flux Φc flowing into the intersection part 5 from the right side of the intersection part 5 in FIG. 2 flows out from the left side of the intersection part 5 with an equal magnitude, and does not pass through the main magnetic path 1 except for the intersection part 5, because the control magnetic path 10 is formed in a bilateral symmetric shape with respect to the intersection part 5 in FIG. 2. To be exact, a leakage component of the control magnetic flux Φc passes through the main magnetic path 1 in the vicinity of the intersection part 5. However, sums of components in the directions of the main magnetic fluxes Φu, Φv, Φw indicated by the arrows in FIG. 1, the components being included in the leakage component of the control magnetic flux, are each zero. In general, in a magnetic material constituting a magnetic path, increases in magnetic flux density when a magnetomotive force is increased are saturated, and thus magnetic reluctance is increased. The larger the magnitude of the control magnetic flux Φc, the higher the composite magnetic flux densities of a magnetic flux density produced in the intersection part 5 by the control magnetic flux Φc and magnetic flux densities in the directions of the main magnetic fluxes perpendicular to the control magnetic flux. Thus, the magnetic reluctance of the intersection part 5 is increased. Consequently, the magnetic reluctance of the main magnetic path 1 as a whole is also increased. Thereby a three-phase reactance in a main circuit can be reduced.

### Second Embodiment

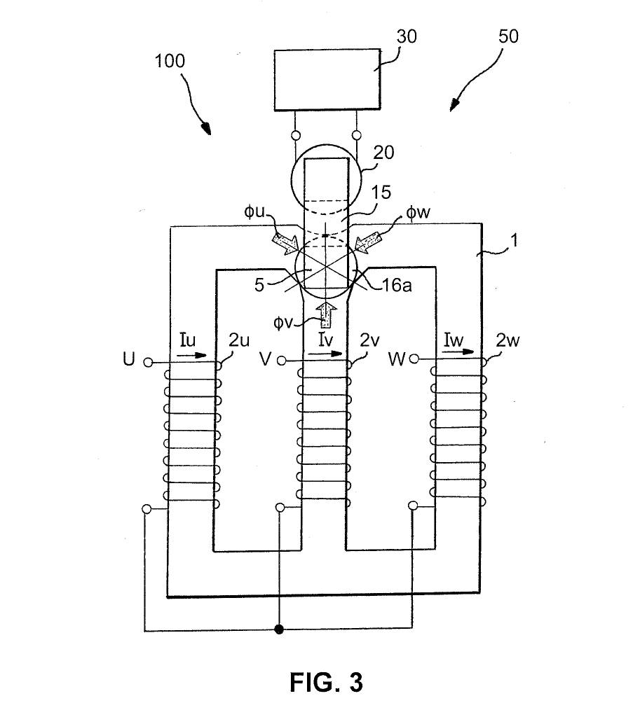

A second embodiment will be described with reference to FIGS. 3 to 6. In the figures, parts identified by the same reference numerals as in FIGS. 1 and 2 are basically equivalent to those in the first embodiment. In the following embodiment, description will be made centering on parts different from those in the embodiment described thus far, and parts whose description is omitted are the same as in the embodiment described thus far unless the parts are technically different.

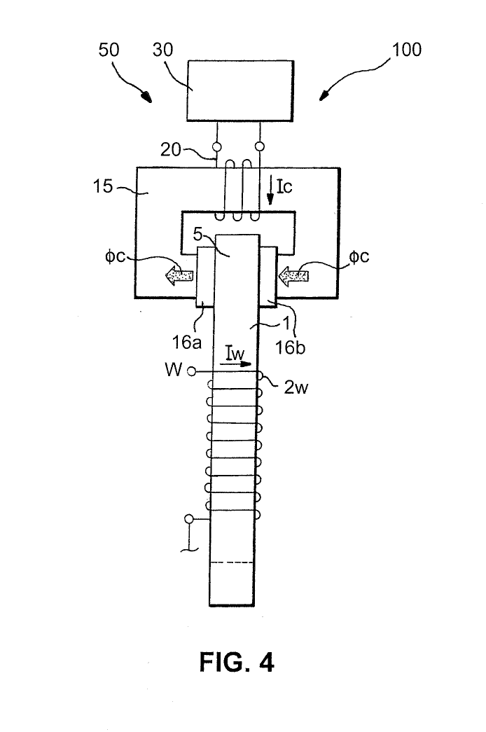

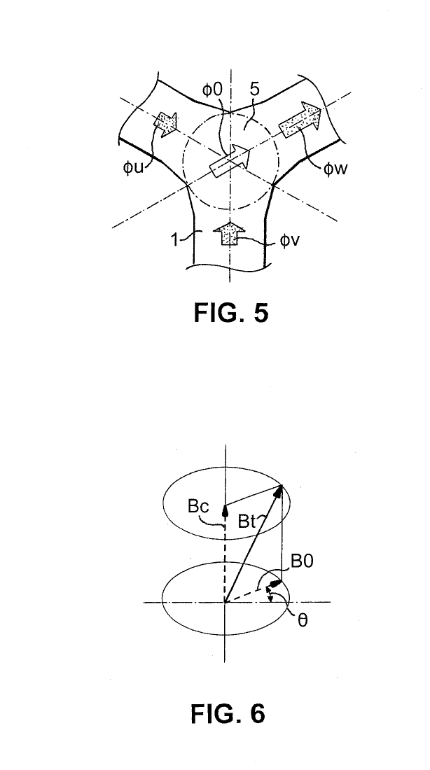

FIG. 3 and FIG. 4 are a front view and a side view, respectively, showing a constitution of a three-phase variable reactor according to the present embodiment. FIG. 5 is a diagram showing the relationship between main magnetic fluxes in the vicinity of an intersection part in the three-phase variable reactor. FIG. 6 is a diagram showing the relationship between magnetic flux densities at the intersection part.

In the present embodiment, the shape of the main magnetic path 1 in the first embodiment shown in FIG. 1 and FIG. 2 is changed to have a 120° rotational symmetry in the vicinity of the intersection part, and the control magnetic path 10 in the first embodiment is changed to a control magnetic path rectangular shape portion 15 and control magnetic path cylindrical shape portions 16a and 16b.

With the constitution described above, a main magnetic flux at the intersection part 5 shown in FIG. 5 forms a rotating magnetic field having a constant magnitude of Φ0 and rotating at a constant speed in the plane of paper when leakage components are ignored. A magnetic flux density component vector attributed to the rotating magnetic field at the intersection part 5 is denoted as BO in FIG. 6. Meanwhile, the control magnetic flux Φc has an axisymmetric shape at the intersection part 5. A magnetic flux density component vector in a direction perpendicular to the plane of paper of FIG. 5, the vector being attributed to the control magnetic flux Φc, is denoted as Bc in FIG. 6. A total magnetic flux density vector Bt is formed as a resultant vector of the magnetic flux density component vectors BO and Bc in FIG. 6. The magnitude of the total magnetic flux density vector Bt is constant when the magnitude of the control magnetic flux Φc is constant. The total magnetic flux density vector Bt rotates at a constant speed in a direction indicated by 0 in FIG. 6 with the passage of time.

Since the magnitude of the total magnetic flux density vector Bt at the intersection part 5 is held constant irrespective of the passage of time as described above, magnetic energy stored in the intersection part 5 does not vary with time either, and a rotating magnetic field rotating at a constant speed is generated. Thus, as compared with the first embodiment, the three-phase reactor according to the present embodiment has an advantageous effect in that the exciting currents Iu, Iv, and Iw have an excellent sinusoidal waveform shape.

It is to be noted that as shown in FIG. 5 and FIG. 6, the essence of the present invention lies in a fact that main magnetic fluxes form a rotating magnetic field at the intersection part 5, and it is therefore obvious that the present invention is applicable to N-phase N-leg main magnetic paths (where N is 3 or more).

### Third Embodiment

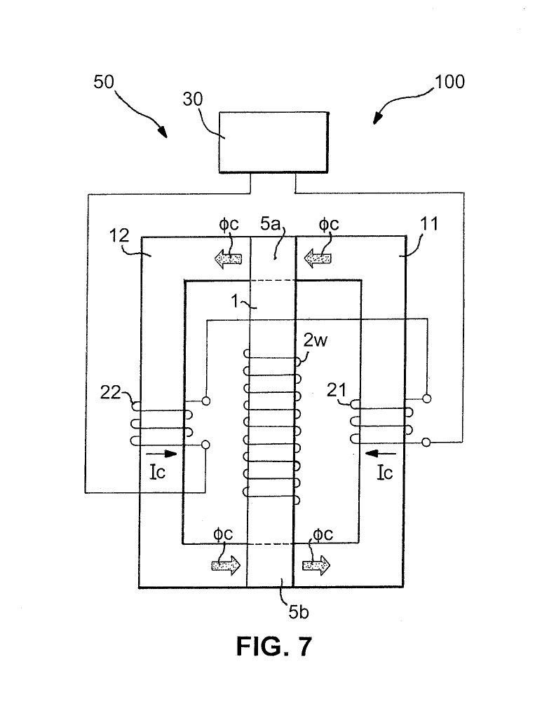

A third embodiment will be described with reference to FIG. 7. FIG. 7 is a side view showing a constitution of a three-phase variable reactor according to the present embodiment.

In the first embodiment shown in FIG. 2, the control magnetic flux generating unit 50 is constituted by the C-shaped control magnetic path 10, the control winding 20, and the control power supply 30, and the control magnetic flux Φc is generated for the intersection part 5. In contrast, in the present embodiment, in order to generate the control magnetic flux Φc for each of two intersection parts 5a and 5b of the main magnetic path 1 shown in FIG. 7, two U-shaped control magnetic paths 11 and 12 are connected to the two intersection parts 5a and 5b, control windings 21 and 22 are wound around the control magnetic paths 11 and 12, respectively, and the control winding 21 and the control winding 22 are connected in series with each other to be connected to the control power supply 30 such that the control current Ic flows in a direction shown in the figure, thereby constituting the control magnetic flux generating unit 50.

With the constitution described above, a dimension in a direction of height of the three-phase variable reactor according to the present embodiment can be reduced as compared with the first embodiment.

### Fourth Embodiment

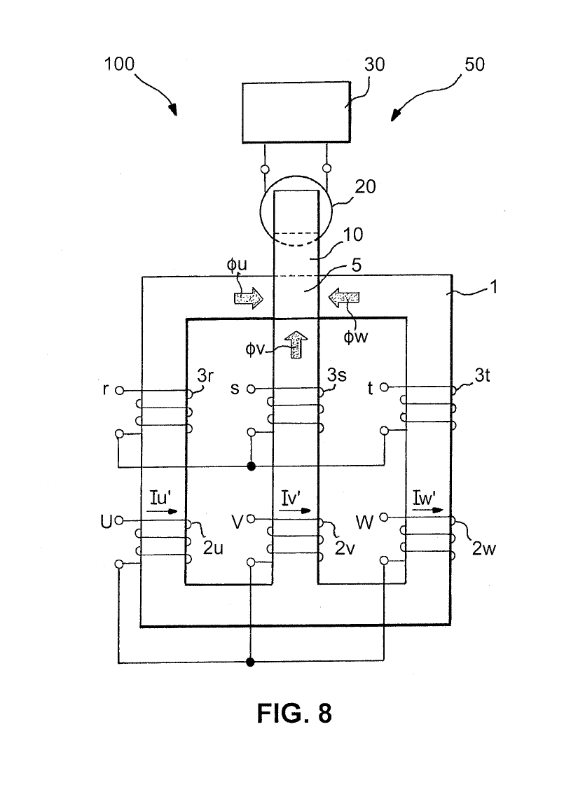

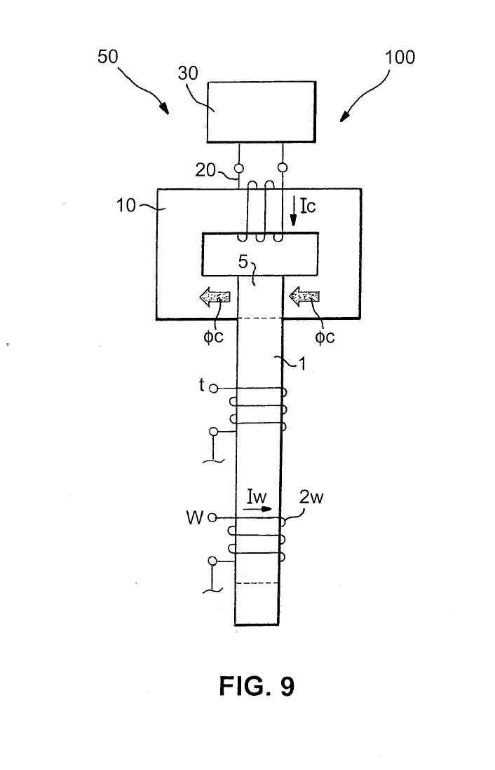

A fourth embodiment will be described with reference to FIG. 8 and FIG. 9. FIG. 8 and FIG. 9 are a front view and a side view, respectively, showing a constitution of a variable reactance three-phase transformer according to the present embodiment.

In the present embodiment, a transformer is constituted by adding secondary windings 3r, 3s, and 3t to the first embodiment shown in FIG. 1 and FIG. 2. An advantageous effect that reactance in primary windings 2u, 2v, and 2w can be varied is similar to that of the first embodiment. Note that currents Iu′, Iv′, and Iw′ flowing through the respective primary windings include exciting current components changed by varying the reactance and load current components.

### Fifth Embodiment

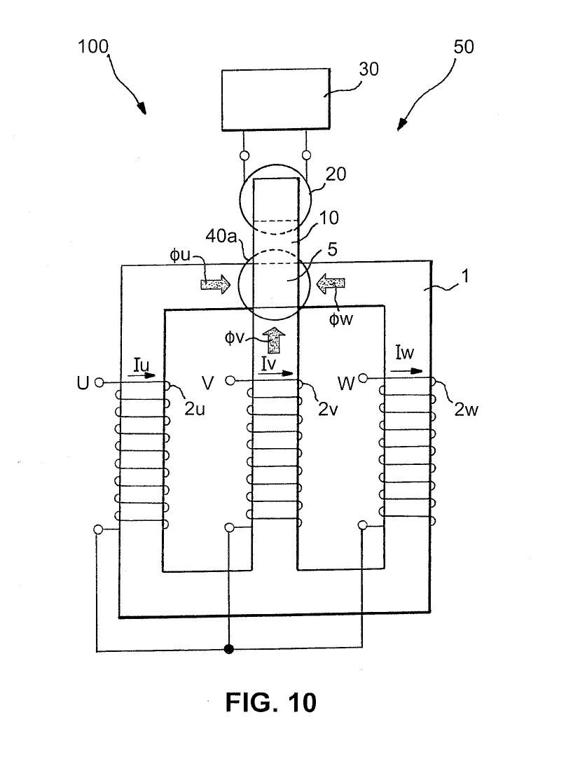

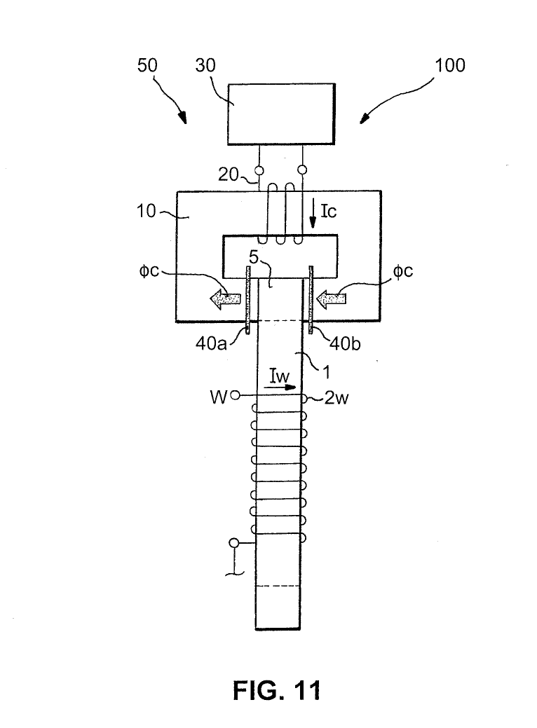

A fifth embodiment will be described with reference to FIG. 10 and FIG. 11. FIG. 10 and FIG. 11 are a front view and a side view, respectively, showing a constitution of a three-phase variable reactor according to the present embodiment.

The present embodiment is constituted by adding compensating windings 40a and 40b wound around the control magnetic path 10 to the first embodiment shown in FIG. 1 and FIG. 2. Both ends of each of the compensating windings are short-circuited.

In the first embodiment, the shape of the main magnetic path 1 is not formed to have a 120° rotational symmetry in the vicinity of the intersection part unlike the second embodiment. Therefore, the magnitude of magnetic flux density resulting from the main magnetic fluxes and the rotational speed are not constant. This causes the magnetic reluctance of the intersection part 5 to vary with time. The magnitude of the control current IC needs to be changed to keep the control magnetic flux Φc constant while the magnetic reluctance varies with time. Thus, the control power supply 30 needs to be selected so as to have such a function of changing the magnitude of the control current IC. On the other hand, in the present embodiment in which the compensating windings 40a and 40b are added, when the control magnetic flux Φc is about to vary with time, current flows in the compensating windings in a direction of canceling the variation, thereby suppressing the variation in the control magnetic flux Φc with time. Thus, the function of changing the control current Ic with time in the control power supply 30 can be reduced or decreased.

What is claimed is:

1. A polyphase stationary induction electric apparatus comprising:
an N-phase N-leg main magnetic path (where N is 3 or more);
a main winding wound around each main leg; and
a control magnetic flux generating unit that generates a control magnetic flux having a magnitude variable in a direction substantially orthogonal to any one of N-phase main magnetic fluxes at an intersection part of N main legs;
the control magnetic flux generating unit controlling the magnitude of the control magnetic flux to make N-phase reactance variable.

2. The polyphase stationary induction electric apparatus according to claim 1, wherein the intersection part is formed to have a shape of 360°/N rotational symmetry.

3. The polyphase stationary induction electric apparatus according to claim 1, wherein a control magnetic flux of an axisymmetric shape is generated at the intersection part.

4. The polyphase stationary induction electric apparatus according to claim 1, wherein the control magnetic flux generating unit has a compensating winding which suppresses temporal variation in the magnitude of the control magnetic flux.
